(19) United States
(12) Patent Application Publication
(10) Pub. No.: US 2010/0085737 A1
(43) Pub. Date: Apr. 8, 2010

(54) CANDLE LIKE LIGHTING DEVICE

(76) Inventor: Chin-Sheng YANG, TAINAN CITY (TW)

Correspondence Address: LEONG C LEI, PMB # 1008, 1867 YGNACIO VALLEY ROAD, WALNUT CREEK, CA, 94598, US

(21) Appl. No.: 12/244,782

(22) Filed: Oct. 3, 2008

(51) Int. Cl. F21V 31/04

(52) U.S. Cl. 362/101

(57) ABSTRACT

A candle-like lighting device is disclosed. The device comprises a decorative seat and a base seat, characterized in that the decorative seat is a transparent configuration, and within the decorative seat a cavity is provided which could hold at least a kind of low boiling point liquid, and the center of the decorative seat is a through hole passing through the decorative seat, and a top cover is provided to the through hole which mounted with a glowing member, and the base seat is mounted with a circuit with light source components, and the circuit is provided with a heat-generating body allowing current to pass through to generate an impedance effect, and the circuit also provides the glowing component of the decorative seat to be connected by a conductive cable to generate light.

### TECHNICAL FIELD OF THE INVENTION

The present invention relates to candle-like lighting device, and in particular, a lighting device having a cavity containing a low boiling point liquid.

### DESCRIPTION OF THE PRIOR ART

FIG. 4 shows a convention candle-like lighting device comprising a transparent container 3 and a bottom seat 4, wherein the transparent container 3 holds a low boiling point liquid B, and the bottom seat 4 is mounted with halogen lamp module 41, which is correspondingly mounted to the base section of the transparent container 3. The base seat with external current supply causes the halogen lamp module 41 to produce light and heat energy to cause the low boiling point liquid B to flow and to reflect light. Thus a decorative effect to the lighting device is obtained.

The light source and heat energy are obtained by the employing of halogen lamp module 41, and the heat energy causes the flow of the low boiling point liquid B. In this instance, the halogen lamp must be of a sufficient wattage otherwise, heat energy generated would be insufficient to cause the effect. If the wattage of the halogen is too large, the cost of electricity is high and the transparent container 3 may be damaged. Further, the light intensity of the light of the halogen lamp module 41 might not sufficient to produce variable ornamental design to the decorative lighting device.

Accordingly, it is an object of the present invention to provide a candle-like lighting device, which overcomes the above drawbacks and provides a new decorative appearance to the lighting device.

### SUMMARY OF THE INVENTION

According to a preferred embodiment of the present invention, there is shown the decorative seat is a transparent configuration, and within the decorative seat a cavity is provided which could hold at least a kind of low boiling point liquid, and the center of the decorative seat is a through hole passing through the decorative seat, and a top cover is provided to the through hole which mounted with a glowing member, and the base seat is mounted with a circuit with light source components, and the circuit is provided with a heat-generating body allowing current to pass through to generate an impedance effect, and the circuit also provides the glowing component of the decorative seat to be connected by a conductive cable to generate light.

Yet an object of the present invention is to provide a candle-like lighting device, wherein the low boiling point liquid is added with a glowing plate.

Still another object of the present invention is to provide a candle-like lighting device, wherein the low boiling point liquid is added with glowing powder.

A further object of the present invention is to provide a candle-like lighting device, wherein the light source component of the circuit is a LED.

Other objects, and advantages will become more apparent in view of the following detailed description in conjunction with the accompanying drawings.

### BRIEF DESCRIPTION OF THE DRAWINGS

FIG. 1 is a perspective exploded view of a candle-like lighting device in accordance with the present invention.

FIG. 2 is a sectional view of a candle-like lighting device in accordance with the present invention.

FIG. 3 is another sectional view of a candle-like lighting device in accordance with the present invention.

FIG. 4 is a perspective exploded view of a conventional candle-like lighting device.

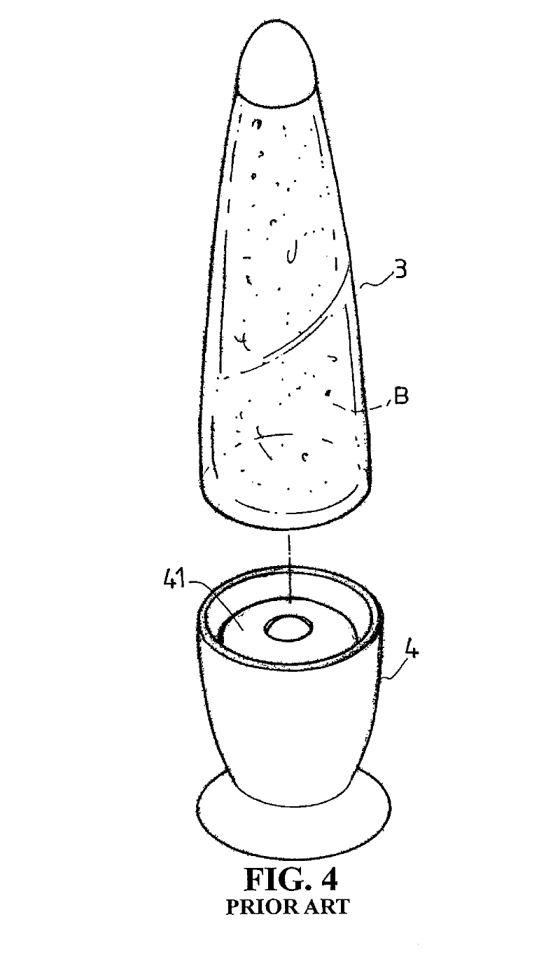

### DETAILED DESCRIPTION OF THE PREFERRED EMBODIMENTS

The following will describe in detail the preferable embodiment of the present invention with a reference to the drawings.

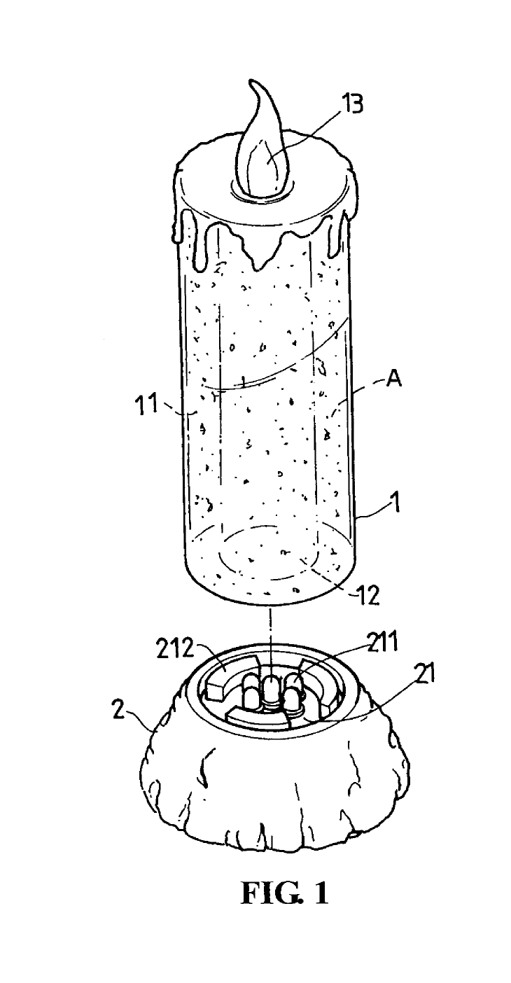

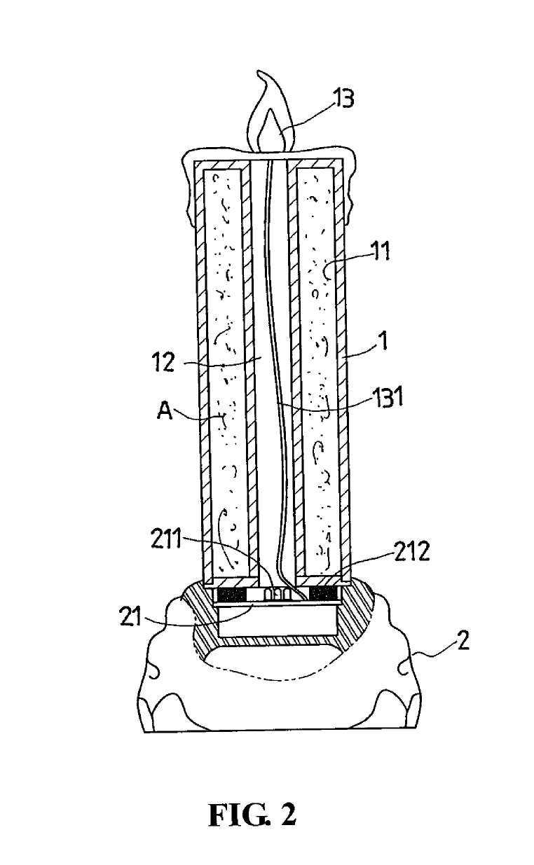

Referring to FIGS. 1 and 2, there is shown a candle-like lighting device in perspective and sectional views, comprising a decorative seat 1 and a base seat 2. In accordance with the preferred embodiment, the decorative seat 1 is a transparent configuration, and the interior of the decorative seat 1 has a cavity containing at least one low boiling point liquid A (for instance, CH2Cl2, and the low boiling point A can be added with glowing plates or glowing powder. Further, the center of the decorative seat 1 is a through hole 12 passing through the decorative seat 1 and the through hole 12 is provided with a top cap mounted with glowing components 13.

The base plate 2 is correspondingly mounted below the decorative seat 1, and the interior of the base seat 2 is provided with circuit structure 21 with light source component 211. The circuit structure 21 is provided with heat generating body 212 which allows current to pass through to generate an impedance effect. The heat generating body 212 is common resistance, cement resistance, electric heating wire or electric heating plate which allow current to pass through so as to generate heat. In addition, the circuit structure 21 is provided to the glowing component 13 on the decorative seat 1 which is linked by conductive wire 131 to generate light.

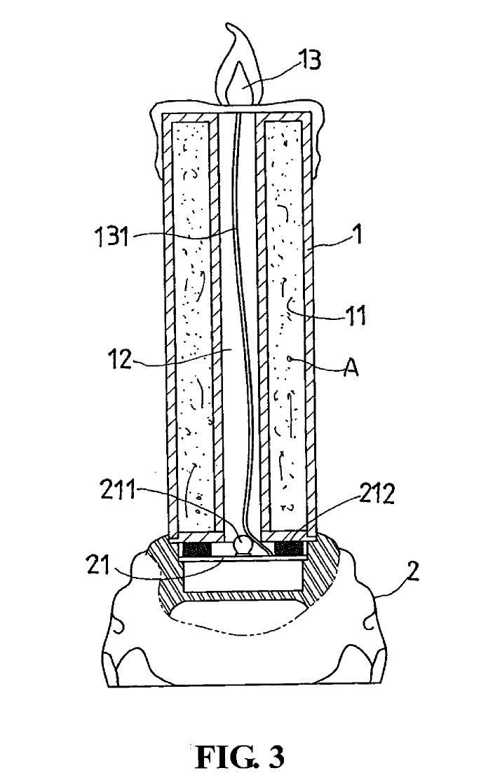

Referring to FIGS. 2 to 3, the cavity 11 of the decorative seat 1 is filled with low boiling point liquid A (for instance CH2CL2) and one end (base section) of the cavity 11 is sealed by low periodic wave method. The through hole 12 of the decorative seat is correspondingly mounted with a glowing member 13 and is connected with a conductive wire 131 passing through the through hole 12. After that, the base seat 2 is mounted with circuit structure 21, and the circuit structure 21 is mounted with a light source element 211 (can be halogen bulb or LED as light source component) and a heat generating body 212, and the conductive wire 131 is correspondingly connected to the circuit structure 21. Thus, the decorative seat 1 is mounted to the base seat 2, and the heat generating body 21 of the base seat is close to the bottom face of the decorative seat 1.

When current is supplied to the circuit structure 21, the heat generating body 212 produces heat and the light from the light source component 211 will shine onto the low boiling point liquid A within the cavity 11 such that the low boiling point liquid A flows by means of the heat from the heat generating body 212, and thus a colourful candle-lie decorative lighting device is obtained. The circuit structure 21 of the base seat 2 supplies current source via the conductive wire 131 such that the glowing component 13 on the low boiling point liquid A produces colourful light.

In accordance with the present invention, the candle-like lighting device possesses the advantages as follows:
(1) The light source component produces light and the heat-generating body producers heat source to the low boiling point liquid. The combination of material of the present invention provides a colourful decorative lighting structure and the use of current is at minimum.
(2) The through hole guides light into the decorative seat, and a glowing component at the top of the through hole provides light. Thus, when the through hole is not limited at one area, the exterior of the decorative seat can give several types of variations.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A candle-like lighting apparatus comprising:
a base seat capable of generating impedance effect to produce heat by passing current and a decorative seat, wherein
the decorative seat is a transparent configuration, and within the decorative seat a cavity is provided which could hold at least a kind of low boiling point liquid, and the center of the decorative seat is a through hole passing through the decorative seat, and a top cover is provided to the through hole which mounted with a glowing member, and the base seat is mounted with a circuit with light source components, and the circuit is provided with a heat-generating body allowing current to pass through to generate an impedence effect, and the circuit also provides the glowing component of the decorative seat to be connected by a conductive cable to generate light.

2. The candle-like lighting apparatus of claim 1, wherein the low boiling point liquid is added with a glowing plate.

3. The candle-like lighting apparatus of claim 2, wherein the low boiling point liquid is added with glowing powder.

4. The candle-like lighting device of claim 1, wherein the heat generating body is cement resistance.

5. The candle-like lighting device of claim 2, wherein the heat generating body is electric wire.

6. The candle-like lighting device of claim 1, wherein the heat generating body is electric heating plate.

7. The candle-like lighting device of claim 1, wherein the light source component of the circuit is a halogen bulb.

8. The candle-like lighting device of claim 1, wherein the light source component of the circuit is a LED.
